(19) United States
(12) Patent Application Publication
(10) Pub. No.: US 2017/0032331 A1
(43) Pub. Date: Feb. 2, 2017

(54) OBJECT MANAGEMENT DEVICE, CLIP, AND OBJECT MANAGEMENT SYSTEM

(71) Applicant: FUJITSU LIMITED, Kawasaki-shi (JP)

(72) Inventors: Kazuki Takano, Hitachiota (JP); Motoshi Sumioka, Kawasaki (JP); Takeshi Osoekawa, Ohta (JP); Takuya Sakamoto, Kawasaki (JP); Daichi Shimada, Kawasaki (JP); Ayuri Morimoto, Osaka (JP); Tazuru Tanamori, Nagoya (JP)

(21) Appl. No.: 15/190,664

(22) Filed: Jun. 23, 2016

(30) Foreign Application Priority Data
Jul. 31, 2015 (JP) 2015-152835

(51) Int. Cl. G06Q 10/10

(52) U.S. Cl. CPC G06Q 10/1097; H04W 88/02

(57) ABSTRACT

A clip detects that the physical link with an object, such as a document, is generated and/or the physical link with an object is eliminated. When the clip detects that the link with an object is generated, the clip transmits an identifier of the clip. Alternatively, when the clip detects that the link with an object is eliminated, the clip transmits an identifier of the clip.

### CROSS-REFERENCE TO RELATED APPLICATION

This application is based upon and claims the benefit of priority of the prior Japanese Patent Application No. 2015-152835, filed on Jul. 31, 2015, the entire contents of which are incorporated herein by reference.

### FIELD

The embodiments discussed herein are related to an object management device, a clip, and an object management system.

### BACKGROUND

Conventionally, users generate To-Do lists, or the like, to manage tasks, such as his/her works or schedules, by using smartphones, or the like. In recent years, there have been known technologies, in which the transmitter, attached to an information storage medium, such as a magnetic tape or sheet, transmits the identifier to the management device on a regular basis, and the management device conducts intensive management.

Japanese Laid-open Patent Publication No. 2003-36429

However, according to the above-described technologies, if a single user manages tasks, its processing and management are complicated. For example, with the technique that uses To-Do lists, as task registration, deletion, or the like, is manually conducted, it is time-consuming. With the technique that uses the transmitter, although the position of the information storage medium, or the like, may be managed by using the identifier, task execution, completion, deletion, or the like, is manually conducted. As described above, task management using the above techniques increases the workload of users, and it is burdensome and time-consuming; therefore, it is hardly easy.

### SUMMARY

According to an aspect of an embodiment, a management device for an object includes a memory; and a processor that is connected to the memory, wherein the processor executes a process. The process includes detecting a physical link with an object is generated and/or a physical link with an object is eliminated; and transmitting an identifier of the management device when detecting that the physical link with the object is generated or the physical link with the object is eliminated.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram that illustrates an example of the overall configuration of a system according to a first embodiment;

FIG. 2 is a functional block diagram that illustrates an example of the functional configuration of the system according to the first embodiment;

FIG. 3 is a diagram that illustrates an example of the format of a request that is transmitted from a clip;

FIG. 4 is a diagram that illustrates an example of the information that is stored in a task DB;

FIG. 5 is a diagram that illustrates an example of the transition of the screen display during task registration;

FIG. 6 is a diagram that illustrates task notification and task deletion;

FIG. 7 is a sequence diagram that illustrates the flow of an operation according to the first embodiment;

FIG. 8 is a diagram that illustrates an example of the overall configuration of a system according to a second embodiment;

FIG. 9 is a functional block diagram that illustrates an example of the functional configuration of a system according to the second embodiment;

FIG. 10 is a diagram that illustrates an example of the information that is stored in a task assignment DB;

FIG. 11 is a diagram that illustrates task assignment according to the second embodiment;

FIG. 12 is a diagram that illustrates an example of a change in the task assignment according to the second embodiment;

FIG. 13 is a sequence diagram that illustrates the flow of an operation according to the second embodiment;

FIG. 14 is a diagram that illustrates an example of simultaneous informing to clips;

FIG. 15 is a diagram that illustrates an example of the alert screen when the clip is not in the neighborhood; and

FIG. 16 is a diagram that illustrates an example of the hardware configuration.

### DESCRIPTION OF EMBODIMENT(S)

Preferred embodiments will be explained with reference to accompanying drawings. Furthermore,, the present invention is not limited to the embodiments. The embodiments may be appropriately combined within the range where there are no contradictions.

### [a] First Embodiment

Overall Configuration

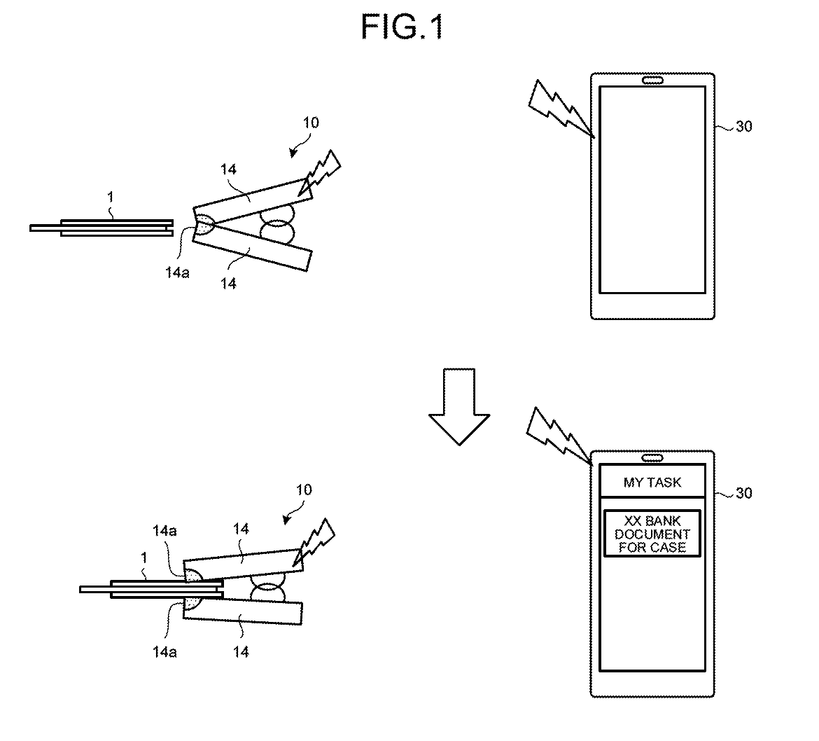

FIG. 1 is a diagram that illustrates an example of the overall configuration of a system according to a first embodiment. As illustrated in FIG. 1, the object management system includes a clip 10 and a smartphone 30. The clip 10 and the smartphone 30 are connected to each other by using a short-range wireless communication, such as Bluetooth (registered trademark, hereinafter sometimes referred to as BT). Furthermore, other than the BT, a short-range wireless communication, such as Near Field Communication (NFC), may be used.

The clip 10 is an example of a device, a management device, or an object management device, which stores a unique identifier and detects that the physical link with an object is made or that the physical link with an object is eliminated. For example, the clip 10 includes a holding unit 14, and it detects that the physical link with a document 1 is made when it nips the document 1 and detects that the physical link with the document 1 is eliminated when it is released from the document 1. Energization sensors 14a are provided oh the edges of the holding unit 14 of the clip 10 so that it is possible to detect whether an object is sandwiched in accordance with the state of the energization sensors 14a. Specifically, the current is applied to the energization sensor 14a in a state where an object is not nipped, and the current is blocked in a state where an object is nipped.

Furthermore, an explanation is given here of a case where the document 1 is an example of the nipped object; however, this is not a limitation, and storage media, such as memory cards or universal serial bus (USB) memories, envelopes, writing tools, or the like, may be also applied. Furthermore, according to the present embodiment, an explanation is given by using the clip 10, including the holding unit 14, as an example; however, this is not a limitation and, for example, envelopes or files, which contain an object, may be used.

The smartphone 30 is an example of a task management device or a first computer that includes a display, touch panel, or the like. Here, an explanation is given by using the smartphone 30 as an example; however, this is not a limitation and, for example, movable terminals, such as mobile phones or Personal Digital Assistant (PDA), or various computers may be applied.

In such a condition, when the clip 10 determines the state of the holding unit 14 and detects that it is in the holding state, it transmits the identifier of the clip ID to the smartphone 30 through the BT. When the smartphone 30 receives the identifier of the clip 10 from the clip 10, it stores the received identifier of the clip 10. Afterward, the smartphone 30 displays the information related to the identifier of the clip 10, stored in a storage unit.

For example, as illustrated in FIG. 1, when the document 1 is nipped, the clip 10 detects that it is in the holding state and transmits the self-owned identifier to the smartphone 30. When the smartphone 30 receives the identifier from the clip 10, it registers the task, related to the received identifier, as a task of the user of the smartphone 30.

Furthermore, when the document 1 is released, the clip 10 detects that it is in the non-holding state and transmits the self-owned identifier to the smartphone 30. When the smartphone 30 receives the identifier from the clip 10, it determines that it is the already-received identifier. Then, the smartphone 30 deletes the task, related to the received identifier, from tasks of the user of the smartphone 30.

In this way, the clip 10 transmits a task entry request to the smartphone 30 when the document 1 is nipped, and it transmits a task completion request to the smartphone 30 when the document is released; therefore, it is possible to manage tasks related to the clipped document by using the smartphone 30 in an easy manner.

Functional Configuration

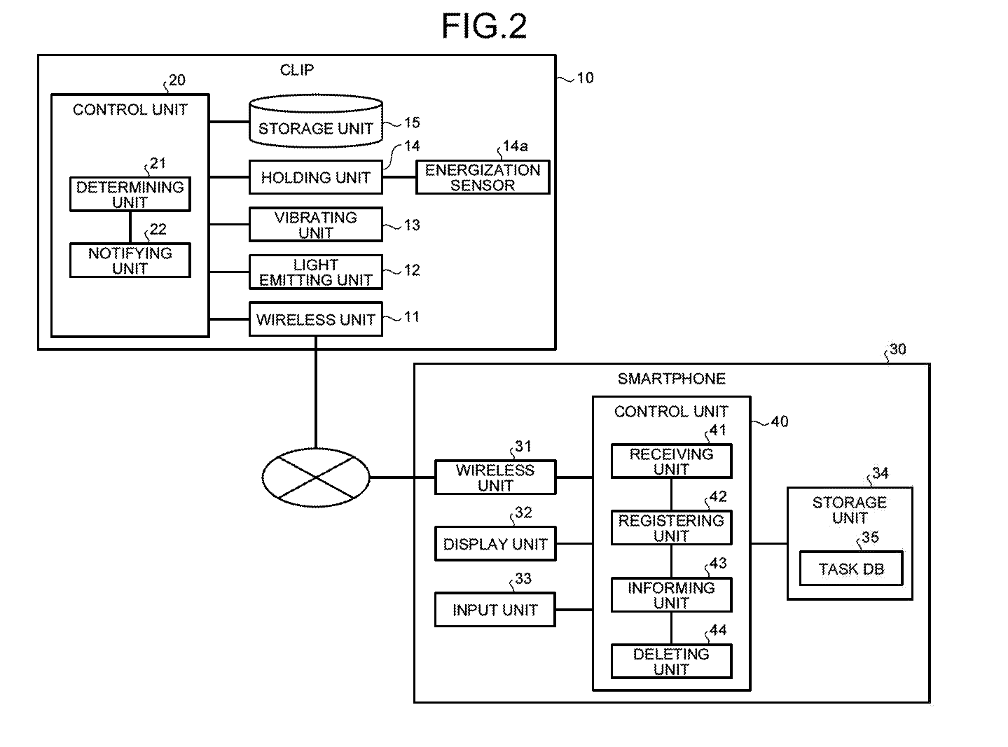

FIG. 2 is a functional block diagram that illustrates an example of the functional configuration of the system according to the first embodiment. Here, an explanation is given of the functional configuration of the clip 10 and the functional configuration of the smartphone 30.

Functional Configuration of the Clip 10

As illustrated in FIG. 2, the clip 10 includes a wireless unit 11, a light emitting unit 12, a vibrating unit 13, the holding unit 14, the energization sensor 14a, a storage unit 15, and a control unit 20.

The wireless unit 11 is a processing unit that performs a short-range wireless communication with the smartphone 30 by using the BT, and it is, for example, a wireless interface. For example, the wireless unit 11 transmits a task entry request, including the identifier, to the smartphone 30, and it transmits a task completion request, including the identifier, to the smartphone 30. Furthermore, the wireless unit 11 transmits signals on a regular basis to conduct detection of the device that is a communication target. Furthermore, any communication method may be used for the communication between the wireless unit 11 of the clip 10 and a wireless unit 31 of the smartphone 30 as long as information may be transmitted and received to and from each other. For example, communication ways, such as broadcast, may be used.

The light emitting unit 12 is a processing unit that emits light in response to a command from the control unit 20, and it is, for example, a light emitting diode (LED). Specifically, the light emitting unit 12 lights up when it receives a lighting-up command from the control unit 20, and it lights off when it receives a lighting-off command from the control unit 20. Here, a light emission pattern may be optionally set for lighting-up, flashing, or the like.

The vibrating unit 13 is a processing unit that vibrates in response to a command from the control unit 20, and it is, for example, a vibration. Specifically, the vibrating unit 13 vibrates when it receives a vibration command from the control unit 20, and it stops vibrating when it receives a stop command from the control unit 20. Here, a vibration pattern may be optionally set.

The holding unit 14 is a processing unit that includes the energization sensor 14a and that nips or releases the document 1. Specifically, the two holding units 14 constitute the single holding unit 14 to perform the holding function. Furthermore, the energization sensor 14a is provided on the section of each of the holding units 14, with which a document is nipped. The energization sensor 14a is a sensor that detects the flow of the current. When the energization sensors 14a, provided on the holding units 14, are brought into contact with each other, the current flows.

For example, the holding unit 14 is in the non-holding state when the energization sensor 14a detects that the current is applied, and it is in the holding state when the energization sensor 14a does not detect that the current is applied. Specifically, if the holding unit 14 is in the holding state, a state is obtained such that the physical link between an object, such as the document 1, and the clip 10 is made, and if the holding unit 14 is in the non-holding state, a state is obtained such that the physical link between an object, such as the document 1, and the clip 10 is eliminated.

The storage unit 15 is a storage device that stores programs or various types of data that are executed by the control unit 20, and it is, for example, a hard disk or memory. The storage unit 15 stores the unique identifier (ID001) that is assigned to the clip 10.

The control unit 20 is a processing unit that performs the overall operation of the clip 10, and it is, for example, a processor. The control unit 20 includes a determining unit 21 and a notifying unit 22. Here, the determining unit 21 and the notifying unit 22 are an example of the electronic circuit, included in a processor, an example of the process that is executed by a processor, or the like.

The determining unit 21 is a processing unit that determines the holding state of the clip 10. Specifically, the determining unit 21 determines whether the clip 10 is in the holding state or the non-holding state on the basis of the state of the energization sensor 14a, included in the holding unit 14, and it outputs a determination result to the notifying unit 22. Therefore, the holding unit 14 or the holding unit 14 and the determining unit 21 in cooperation operate as a detecting unit that detects that the clip 10 nips an object, i.e., the physical link with an object is made and/or the physical link with an object is eliminated.

For example, the determining unit 21 determines that the holding unit 14 is in the holding state when the document 1 is nipped and the state of the energization sensor 14a is changed from being applied with current to being not applied with current. Usually, when a user nips an object with the clip 10, the object is nipped while the opened state of the clip 10 is kept for a predetermined time period. Therefore, if the no-current carrying state of the energization sensor 14a continues for a predetermined time period, the determining unit 21 may determine that the holding unit 14 is in the holding state. Furthermore, the determining unit 21 determines that the holding unit 14 is in the non-holding state when the document 1 is released and the state of the energization sensor 14a is changed from being not applied with current to being applied with current.

The notifying unit 22 is a processing unit that transmits various requests to the smartphone 30 in accordance with a change in the holding state that is determined by the determining unit 21. Therefore, it operates as a transmitting unit or a wireless transmitting unit from the clip 10 to the smartphone 30. Specifically, when the state of the holding unit 14 is changed from the non-holding state to the holding state, the notifying unit 22 transmits the task entry request that includes the identifier, stored in the storage unit 15, to the smartphone 30. Furthermore, when the state of the holding unit 14 is changed from the holding state to the non-holding state, the notifying unit 22 transmits the task cancel request that includes the identifier, stored in the storage unit 15, to the smartphone 30.

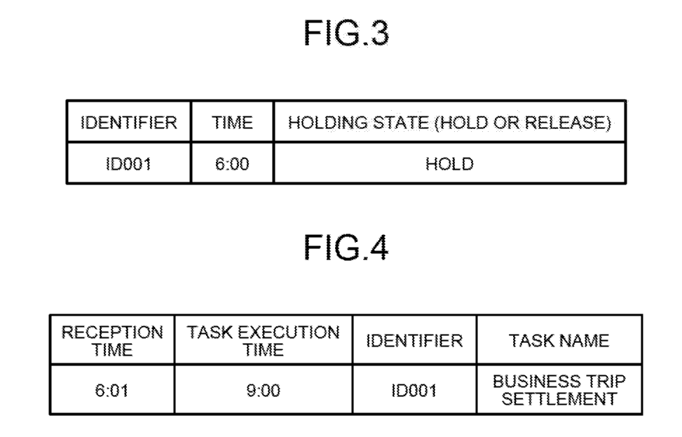

Here, an explanation is given of various requests that are transmitted by the notifying unit 22. FIG. 3 is a diagram that illustrates an example of the format of a request (signal) that is transmitted from the clip. As illustrated in FIG. 3, the various requests include “identifier, time, holding state”. The “identifier” is the identifier that is stored in the storage unit 15, and it is “ID001” according to the present embodiment. The “time” is the time at which the holding state is determined. The “holding state” is the information for specifying the determination result that is determined by the determining unit 21, and “Hold” is set in a case where it is the holding state and “Release” in a case where it is the non-holding state.

For example, if the determining unit 21 determines that the holding unit 14 is in the holding state at 6:00, the notifying unit 22 transmits the entry request that is made up of “ID001, 6:00, Hold” to the smartphone 30. Afterward, if the determining unit 21 determines that the holding unit 14 is in the non-holding state at 12:00, the notifying unit 22 transmits the cancel request that is made up of “ID001, 12:00, Release” to the smartphone 30.

Furthermore, the format illustrated here is an example, and this is not a limitation. For example, if the task name is previously stored in the clip 10, the notifying unit 22 may include “the task name” for transmission other than the information that is illustrated in FIG. 3. Furthermore, the notifying unit 22 may transmit only the identifier without including the time information or the information on the holding state. Furthermore, the notifying unit 22 may include the task start time, or the like.

Functional Configuration of the Smartphone 30

As illustrated in FIG. 2, the smartphone 30 includes the wireless unit 31, a display unit 32, an input unit 33, a storage unit 34, and a control unit 40.

The wireless unit 31 is a processing unit that performs a short-range wireless communication with the clip 10 by using the BT, and it is for example a wireless interface. For example, the wireless unit 31 receives a task entry request or deletion request, including the identifier, from the clip 10. Furthermore, the wireless unit 31 transmits a vibration command, lighting-up command, lighting-off command, or the like, to the clip 10.

The display unit 32 is a processing unit that displays various types of information, and it is for example a touch panel. For example, the display unit 32 displays the information related to a registered task. The input unit 33 is a processing unit that receives an input of various types of information from a user, and it is for example a software keyboard. For example, the input unit 33 receives an input of the task name registration, change, or the like, and outputs it to the control unit 40.

The storage unit 34 is a storage device that stores programs or various types of data that are executed by the control unit 40, and it is, for example, a hard disk or a memory. The storage unit 34 stores a task DB 35.

The task DB 35 is a database that stores the information related to a registered task. FIG. 4 is a diagram that illustrates an example of the information that is stored in the task DB 35. As illustrated in FIG. 4, the task DB 35 stores “reception time, task execution time, identifier, task name” in a related manner.

The “reception time” stored here is the time at which an entry request is received. The “task execution time” is a task start time, and it may be specified by the clip 10 or may be set by a user on the side of the smartphone 30. The “identifier” is the identifier of the clip 10, registered as a task. The “task name” is the name of a task, displayed in the task list, and it may be specified by the clip 10 or may be set by a user on the side of the smartphone 30.

The example of FIG. 4 illustrates that the entry request, transmitted from the clip 10 with the identifier “ID001”, is received at “6:01”, the task name of the task is “business trip settlement”, and the start time of the task is “9:00”. Furthermore, the task DB 35 stores the information that is used for the BT communication, which may be acquired, from the information that is received by a receiving unit 41, in relation to each task.

The control unit 40 is a processing unit that performs the overall operation of the smartphone 30, and it is for example a processor. The control unit 40 includes the receiving unit 41, a registering unit 42, an informing unit 43, and a deleting unit 44. Here, the receiving unit 41, the registering unit 42, the informing unit 43, and the deleting unit 44 are an example of the electronic circuit, included in a processor, an example of the process that is executed by a processor, or the like.

The receiving unit 41 is a processing unit that receives a task entry request or a task cancel request from the clip 10, received by the wireless unit 31. Specifically, the receiving unit 41 receives various requests that are described by using the format that is illustrated in FIG. 3. Furthermore, if “Hold” is registered in the holding state of the received request, the receiving unit 41 determines that it is an entry request, and it outputs the received information to the registering unit 42. Furthermore, if “Release” is registered in the holding state of the received request, the receiving unit 41 determines that it is a cancel request, and it outputs the received information to the deleting unit 44.

According to another embodiment, if the identifier, included in the received request, is not registered in the task DB 35, the receiving unit 41 determines that it is an entry request and outputs the received information to the registering unit 42. Furthermore, if the identifier, included in the received request, is registered in the task DB 35, the receiving unit 41 determines that it is a cancel request and outputs the received information to the deleting unit 44.

The registering unit 42 is a processing unit that registers a task in the task DB 35. Specifically, if the receiving unit 41 receives the entry request, the registering unit 42 stores various types of information, included in the entry request, as a task in the task DB 35. For example, if the entry request “identifier=ID001, holding state=Hold” is received, the registering unit 42 stores the reception time and the identifier “ID001” in the task DB 35 in a related manner. Afterward, the registering unit 42 receives the settings, such as “task execution time” or “task name”, via the display unit 32 or the input unit 33 and stores the received information in the task DB 35.

According to another embodiment, if the entry request “identifier=ID001, task execution time=9:00, task name=business trip settlement, holding state=Hold” is received, the registering unit 42 stores the reception time, the identifier, the task name, and the task execution time in the task DB 35 in a related manner. In this way, the registering unit 42 registers the received information as a task and may also prompt a user to register the missing information as a task.

Furthermore, if the task name, or the like, has not been input yet, the registering unit 42 may temporarily register any information, such as “task of ID001” or “task XX” until the task name is input. Furthermore, the registering unit 42 may register an entry request in the task DB 35 in the order it is received and may sort it in the order of the task execution time. Furthermore, the registering unit 42 extracts the information, used for the BT communication, from the information that is received by the receiving unit 41 and stores it by being related to each task.

The informing unit 43 is a processing unit that informs a user of the task that is the target to be executed. Specifically, the informing unit 43 refers to the task DB 35 and, if it detects the task that reaches the task execution time, transmits a vibration command to the clip 10 that includes the identifier that is related to the task. Thus, it is possible to prevent a task from being left unexecuted even if the user forgets the start time of the task or the place of the document 1 that is nipped with the clip.

Furthermore, if the deleting unit 44 deletes a task from the task DB 35, the informing unit 43 refers to the task DB 35 and determines whether there is the subsequent task to be executed. Then, if there is the subsequent task to be executed, the informing unit 43 transmits a lighting-up command to the clip 10, including the identifier that is related to the task. This allows the informing unit 43 to notify a user of the presence of the unprocessed task.

The deleting unit 44 is a processing unit that deletes a processed task from the task list. Specifically, if the receiving unit 41 receives a cancel request, the deleting unit 44 deletes the task from the task DB 35. Then, the deleting unit 44 notifies the informing unit 43 that the task has been deleted.

For example, if the cancel request “identifier=ID001, holding state=Release” is received, or if the identifier “ID001” is received from the receiving unit 41, the deleting unit 44 deletes the task, related to the identifier “ID001”, from the task DB 35.

Explanation on Task Registration

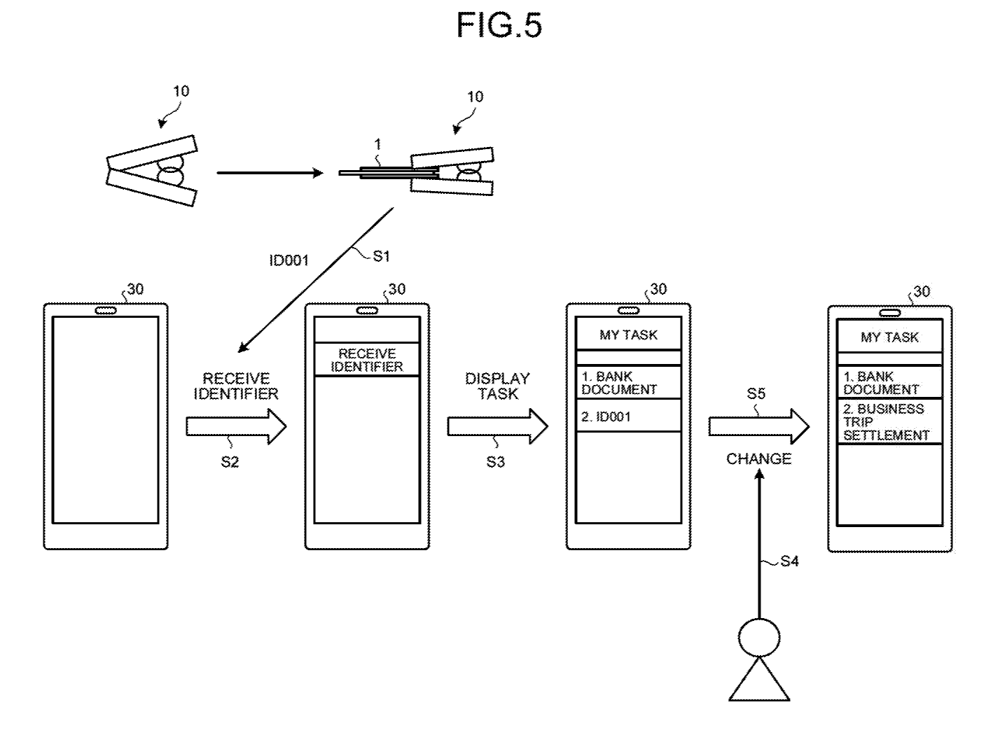

FIG. 5 is a diagram that illustrates an example of the transition of the screen display during task registration. As illustrated in FIG. 5, when, the clip 10 detects that the document 1 is nipped, it transmits the identifier “ID001” to the smartphone 30 (S1). When the smartphone 30 receives the identifier, it displays the received identifier on the display unit 32 (S2).

Next, the smartphone 30 registers the task, related to the received identifier, in the task DB 35 and displays the registered task list on the display unit 32 (S3). Furthermore, in the example illustrated here, as the task name has not been set yet, the identifier “ID001” is displayed as the task name.

Afterward, when the smartphone 30 receives, from the user, a change in the task name of the task, related to the identifier “ID001”, it updates the task DB 35 by using the received task name “business trip settlement” (S4). Next, the smartphone 30 displays the task list, registered in the task DB 35 (S5).

Explanation on Task Cancel

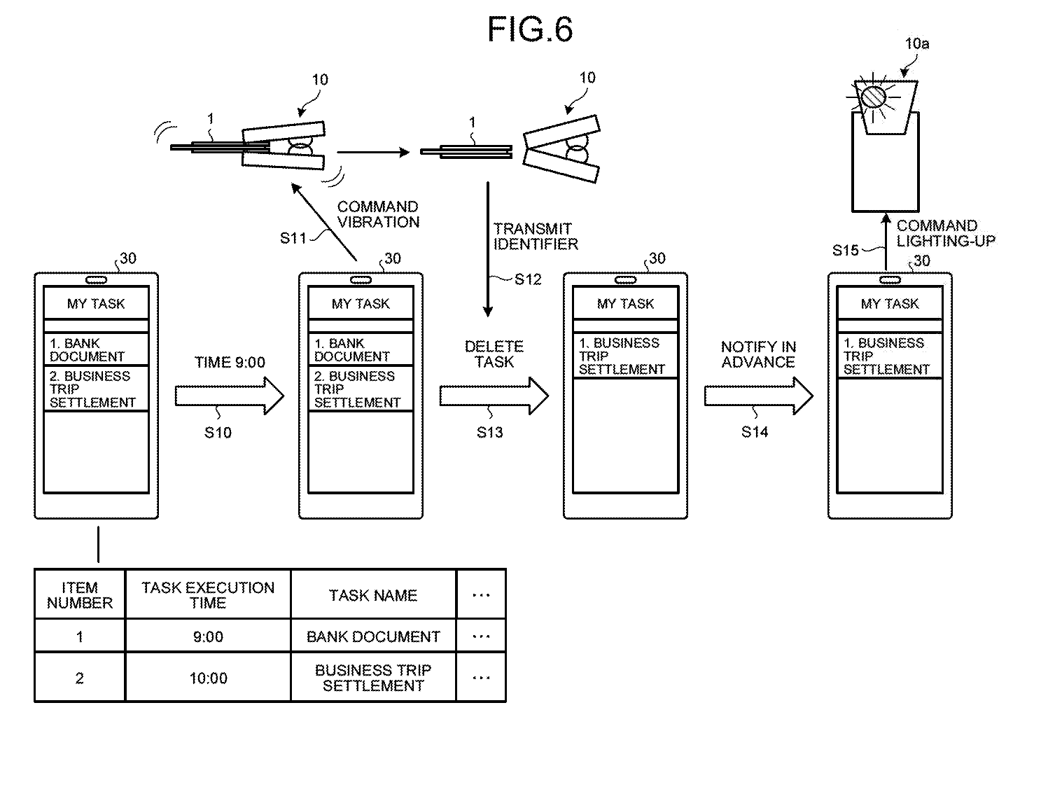

FIG. 6 is a diagram that illustrates task notification and task deletion. Here, in the example illustrated in FIG. 6, each of the two clips, i.e., the clip 10 and a clip 10a, registers a task. Furthermore, the clip 10a also has the same functional configuration as that of the clip 10.

As illustrated in FIG. 6, the smartphone 30 stores a task list. Specifically, the smartphone 30 stores “1, 9:00, bank document, . . . ” and “2, 10:00, business trip settlement, . . . ” as “item number, task execution time, task name, . . . ”.

In the above-described condition, when the time is 9:00, the smartphone 30 determines that it is the start-time of the task “bank document” with the item number 1 (S10). Then, the smartphone 30 transmits a vibration command to the clip 10, related to the identifier of the task “bank document”, and the clip ID starts to vibrate in accordance with the vibration command (S1).

Afterward, when the clip 10 detects that the document 1 is released, it transmits the identifier to the smartphone 30 (S12). When the smartphone 30 receives the identifier, it deletes the task “1, 9:00, bank document, . . . ”, which is stored in relation to the received identifier, and upgrades the task “business trip settlement” with the item number 2 to the item number 1 (S13).

Then, as there is still an unprocessed task, the smartphone 30 specifies the subsequent task to be executed in the task DB 35 (S14). Then, the smartphone 30 transmits a lighting-up command to the clip 10a, related to the identifier of the subsequent task to be executed (S15). After the clip 10a receives the command, it lights up a light emitting unit, such as an LED.

Flow of the Operation

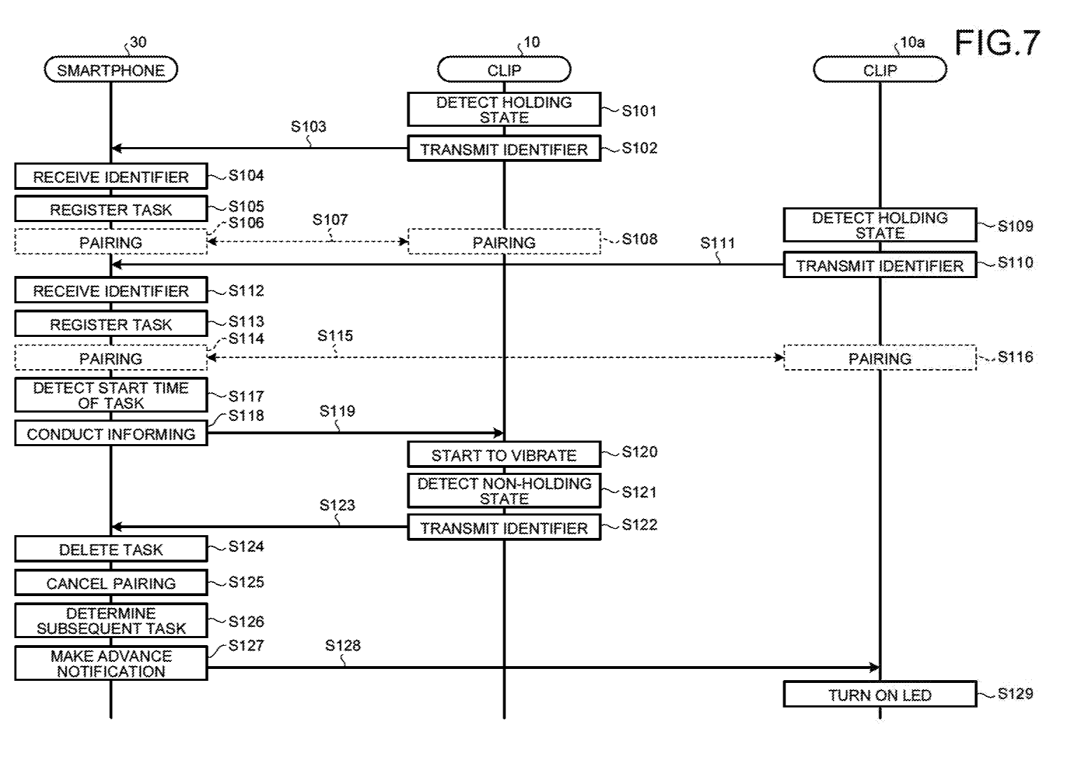

FIG. 7 is a sequence diagram that illustrates the flow of an operation according to the first embodiment. As is the case with FIG. 6, in the example illustrated in FIG. 7, each of the two clips, i.e., the clip 10 and the clip 10a, registers a task. Furthermore, as the clip 10 and the clip 10a have the same functional configuration, the same reference numerals are used for the processing units. Moreover, the clip 10 stores the identifier (ID001), and the clip 10a stores the identifier (ID002).

As illustrated in FIG. 7, after the determining unit 21 of the clip 10 detects the holding state of the holding unit 14 (S101), the notifying unit 22 of the clip 10 transmits the entry request, including the identifier (ID001), to the smartphone 30 (S102 and S103).

Then, after the receiving unit 41 of the smartphone 30 receives the entry request, including the identifier, from the clip 10 (S104), the registering unit 42 registers the task, related to the received identifier, in the task DB 35 (S105). Furthermore, the task registered here is the task (ID001).

Furthermore, if needed, the registering unit 42 conducts pairing for the clip 10, for which the task registration has been made (S106 to S108). Here, the timings tor conducting pairing are not limited to those illustrated in the drawing, and it may be executed at any time between the task registration, and the task start time.

Similarly, after the determining unit 21 of the clip 10a detects the holding state of the holding unit 14 (S109), the notifying unit 22 of the clip 10a transmits the entry request, including the identifier (ID002), to the smartphone 30 (S110 and S111).

Then, after the receiving unit 41 of the smartphone 30 receives the entry request, including the identifier, from the clip 10a (S112), the registering unit 42 registers the task, related to the received identifier, in the task DB 35 (S113). Furthermore, the task registered here is the task (ID002).

Furthermore, if needed, the registering unit 42 conducts pairing for the clip 10, for which the task registration has been made (S114 to S116). Here, the timings for conducting pairing are not limited to those illustrated in the drawing, and it may be executed at any time between the task registration and the task start time.

Afterward, when the informing unit 43 of the smartphone 30 detects the start time of the task (ID001) (S117), it informs the clip 10, related to the task (ID001), of a vibration command, or the like (S118 and S119).

Then, after the vibrating unit 13 of the clip 10 receives the vibration command from the smartphone 30, it starts to vibrate (S120). Afterward, when the task is executed and the document, or the like, is released from the clip 10, the determining unit 21 of the clip 10 detects that it is the non-holding state (S121). Then, the notifying unit 22 of the clip 10 transmits the deletion request, including the identifier (ID001), to the smartphone 30 (S122 and S123).

Then, after the deleting unit 44 of the smartphone 30 receives the cancel request from the clip 10, it deletes the task (ID001) from the task DB 35 (S124). Afterward, the deleting unit 44 cancels pairing with the clip 10 (S125).

Next, the informing unit 43 of the smartphone 30 determines that the task (ID002) is registered as the subsequent task (S126). Then, the informing unit 43 makes an advance notification, such as a lighting-up command, to the clip 10a that is related to the task (ID002) (S127 and S128). After the light emitting unit 12 of the clip 10a receives the notification, it turns on the LED (S129).

Advantages

As described above, users may easily register tasks in the smartphone 30 by nipping an object, such as document, with each clip and may easily delete tasks from the smartphone 30 by releasing an object from the clip. Thus, users may manage the physical object, which is the target for the task, and the information, which is the task, by being easily related to each other. Furthermore, users may manage tasks by performing operations to arrange physical objects, which are the targets for the tasks, without performing any difficult operations; therefore, tasks may be managed as an extension of daily activities, and user's own tasks may be managed in an easy way.

Furthermore, as tasks may be managed by users using the smartphone 30, task edition, management, or the like, may be easily conducted. Furthermore, after a task is completed, the smartphone 30 may light up the LED, or the like, of the clip that corresponds to the subsequent task; therefore, it is possible to prevent users from forgetting the task, or the like.

### [b] Second Embodiment

In the example illustrated according to the first embodiment, tasks are managed by using the single smartphone 30; however, this is not a limitation, and tasks may be managed by using multiple smartphones. Therefore, according to a second embodiment, an explanation is given of the example where tasks are managed by using multiple smartphones.

Overall Configuration

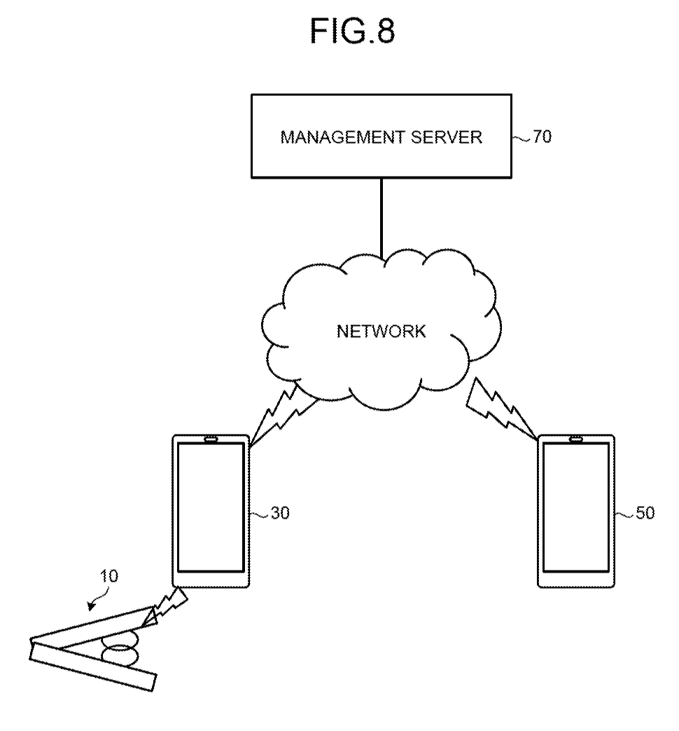

FIG. 8 is a diagram that illustrates an example of the overall configuration of a system according to the second embodiment. As illustrated in FIG. 8, the system includes the clip 10, the smartphone 30, a smartphone 50, and a management server 70. The clip 10 is connected to each smartphone by using a wireless communication, such as BT. Each smartphone is connected to the management server 70 via a network. As this network, any type of communication network, such as a local area network (LAN) or virtual private network (VPN), as well as the Internet may be used regardless of whether it is wired or wireless.

As is the case with the first embodiment, the clip 10 is an example of the device that stores the unique identifier and detects that the physical link with an object is made or the physical link with an object is eliminated. As is the case with the first embodiment, the smartphone 30 and the smartphone 50 are an example of the task management device or the first computer that includes a display, touch panel, or the like. The management server 70 is a server device that assigns a task to each smartphone, and it is an example of the second computer.

In the above-described condition, for example, if the clip 10 detects that the physical link with an object, such as a document, is made, it transmits its own identifier to the smartphone 30 that is located at the position where a short-range communication may be performed. When the smartphone 30 receives the identifier from the clip 10 that is located at the position where a short-range communication may be performed, it transmits the received identifier of the clip 10 and its own identifier to the management server 70. The management server 70 receives the identifier of the clip 10 and the identifier of the smartphone 30. Furthermore, if the received identifier of the clip 10 has not been stored yet, the management server 70 stores the identifier of the clip 10 and the identifier of the smartphone 30 in a related manner. Conversely, if the received identifier of the clip 10 has been stored, the management server 70 updates the identifier of a different smartphone, stored in relation to the identifier of the clip 10, by using the received identifier of the smartphone 30.

That is, if the clip 10 nips an object, the smartphone 50, which is located at the position where it may perform a BT communication with the clip 10, transmits the identifier of the clip 10 to the management server 70. Furthermore, if the identifier of the clip 10 is not registered as a task, the management server 70 assigns it as a new task for the smartphone 50. Conversely, if the identifier of the clip 10 has been already registered as a task, the management server 70 changes the assignment destination of the task to the smartphone 50.

In this way, tasks may be managed by using multiple smartphones; therefore, a single task may be shared within a company, for example, and tasks may be easily managed by multiple persons.

Functional Configuration

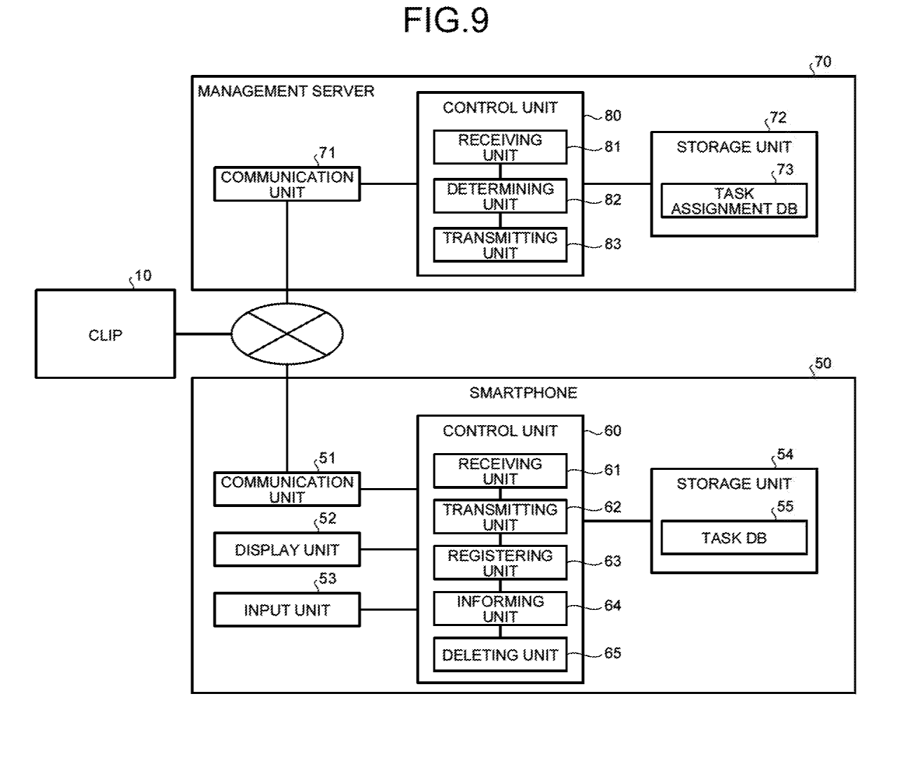

FIG. 9 is a functional block diagram that illustrates an example of the functional configuration of the system according to the second embodiment. As the clip 10 has the same functionality as that in the first embodiment, the detailed explanations are omitted here. For example, if the holding state is changed, the clip 10 retrieves the smartphone that is capable of short-range communication, and it transmits the state (Hold or Release) of the holding unit 14 and the identifier to the retrieved smartphone. Furthermore, if the clip 10 retrieves a new smartphone that is capable of short-range communication regardless of changes in the holding state, it transmits the state of the holding unit 14 and the identifier to the retrieved smartphone.

Furthermore, as the smartphone 30 and the smartphone 50 have the same configuration, an explanation is given here by using the smartphone 50 as an example. Moreover, in the following explanations, the same reference numerals as those of the smartphone 50 are used for the processing units of the smartphone 30.

Functional Configuration of the Smartphone 50

As illustrated in FIG. 9, the smartphone 50 includes a communication unit 51, a display unit 52, an input, unit 53, a storage unit 54, and a control unit 60.

The communication unit 51 is a processing unit that performs a short-range wireless communication with the clip 10 by using the BT and that performs transmission and reception of data with the management server 70 via various types of networks. For example, the communication unit 51 receives a task entry request or deletion request, including the identifier of the clip 10, from the clip 10. Furthermore, the communication unit 51 transmits a vibration command, a lighting-up command, a lighting-off command, or the like, to the clip 10.

Furthermore, the communication unit 51 transmits the identifier of each of the clips 10 and the identifier of the smartphone 50 to the management server 70. The communication unit 51 receives a task registration command or a task deletion command from the management server 70.

The display unit 52 is a processing unit that displays various types of information, and it is, for example, a touch panel. For example, the display unit 52 displays the information about the registered task. The input unit 53 is a processing unit that receives an input of various types of information from the user, and it is, for example, a software keyboard. For example, the input unit 53 receives an input of registration, change, or the like, of the task name and outputs it to the control unit 60.

The storage unit 54 is a storage device that stores programs and various types of data that are executed by the control unit 60, and it is, for example, a hard disk or a memory. The storage unit 54 stores a task DB 55. The task DB 55 is a database that stores the information about the registered task. The information, stored in the task DB 55, is the same as that in the first embodiment, and therefore the detailed explanations are omitted.

Furthermore, the storage unit 54 stores “SMP002” as the identifier that is assigned to the smartphone 50. Here, the storage unit 54 of the smartphone 30 stores “SMP001” as the identifier that is assigned to the smartphone 30.

The control unit 60 is a processing unit that performs the overall operation of the smartphone 50, and it is for example a processor. The control unit 60 includes a receiving unit 61, a transmitting unit 62, a registering unit 63, an informing unit 64, and a deleting unit 65. Here, the receiving unit 61, the transmitting unit 62, the registering unit 63, the informing unit 64, and the deleting unit 65 are an example of the electronic circuit, included in a processor, an example of the process that is executed by a processor, or the like.

The receiving unit 61 is a processing unit that receives various types of information from the clip 10 or the management server 70. Specifically, the receiving unit 61 receives a task entry request, a task cancel request, or the like, which is transmitted due to a change in the holding state by the clip 10. Furthermore, the receiving unit 61 outputs the received information to the transmitting unit 62. Here, the received information is the same as that in the first embodiment; therefore, detailed explanations are omitted.

Furthermore, the receiving unit 61 receives the combination of the state of the holding unit 14 and the identifier, or the like, which is transmitted by the clip 10 due to the detection of a new BT connection destination. Specifically, the receiving unit 61 receives the information that is transmitted from the clip 10 due to a change in the storage area of the clip 10, or the like. For example, the receiving unit 61 receives the state “Hold” of the holding unit 14 and the identifier (ID001) and outputs them to the transmitting unit 62.

Furthermore, the receiving unit 61 receives a task registration command or task deletion command from the management server 70. For example, as a task registration command, the receiving unit 61 receives the task registration command and the identifier of the clip 10 from the management server 70. Then, the receiving unit 61 outputs the received task registration command to the registering unit 63. Furthermore, as a task deletion command, the receiving unit 61 receives the task deletion command and the identifier of the clip 10 from the management server 70. Then, the receiving unit 61 outputs the received task deletion command to the deleting unit 65. Furthermore, if the receiving unit 61 receives an entry request from the clip 10, it may measure the intensity of received radio waves.

The transmitting unit 62 is a processing unit that transmits the information, received from the clip 10, to the management server 70. Specifically, the transmitting unit 62 transmits an entry request or a deletion request, received from the clip 10, to the management server 70 and requests the management server 70 to assign a task or delete a task.

For example, if the transmitting unit 62 receives the entry request “identifier (ID001), time (6:00), holding state (Hold)”, illustrated in FIG. 3, from the clip 10, it adds its own identifier (SMP002) to the entry request and transmits it to the management server 70. In the same manner, if the transmitting unit 62 receives the deletion request “identifier (ID001), time (9:00), holding state (Release)” from the clip 10, it adds its own identifier (SMP002) to the deletion request and transmits it to the management server.

Furthermore, if the transmitting unit 62 receives the combination of the state “Hold” of the holding unit 14 and the identifier (ID001) from the receiving unit 61, it adds its own identifier (SMP002) to the combination and transmits it to the management server 70.

The registering unit 63 is a processing unit that registers a task in the task DB 55 in response to a command from the management server 70. Specifically, if the receiving unit 61 receives the task registration command and the identifier of the clip 10, the registering unit 63 registers the task, related to the received identifier of the clip 10, in the task DB 55. Here, the registered information is the same as that in the first embodiment; therefore, detailed explanations are omitted.

The informing unit 64 is a processing unit that informs a user of the task that is the target to be executed. Here, the informing unit 64 performs the same operation as that of the informing unit 43 that is explained in the first embodiment; therefore, detailed explanations are omitted.

The deleting unit 65 is a processing unit that deletes a processed task from the task list. Specifically, if the receiving unit 61 receives the task deletion command and the identifier of the clip 10, the deleting unit 65 deletes the task, related to the received identifier of the clip 10, from the task DB 55.

Functional Configuration of the Management Server 70

As illustrated in FIG. 9, the management server 70 includes a communication unit 71, a storage unit 72, and a control unit 80.

The communication unit 71 is a processing unit that performs transmission and reception of data with each smartphone via various networks. For example, the communication unit 71 receives, from the smartphone 50, various types of information, such as a task entry request or deletion request, including the identifier of the clip 10 and the identifier of the smartphone 50. Furthermore, the communication unit 51 transmits a task registration command, deletion command, or the like, to the smartphone 50, or the like.

The storage unit 72 is a storage device that stores programs and various types of data that are executed by the control unit 80, and it is, for example, a hard disk or a memory. The storage unit 72 stores a task assignment DB 73.

The task assignment DB 73 is a database that stores task assignment information that is specified by the clip 10. Specifically, the task assignment DB 73 is a database that conducts management as to which one of the smartphones a task is assigned to.

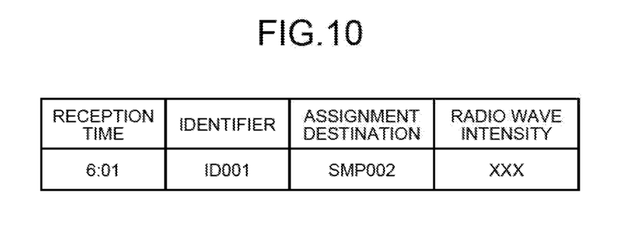

FIG. 10 is a diagram that illustrates an example of the information that is stored in the task assignment DB 73. As illustrated in FIG. 10, the task assignment DB 73 stores “reception time, identifier, assignment destination, radio wave intensity” in a related manner. The “reception time” is the time at which a task entry request is received. The “identifier” is the identifier of the clip, registered as a task. The “assignment destination” is the identifier of the smartphone to which a task is assigned. The “radio wave intensity” is the intensity of received radio waves when the smartphone receives a task entry request from the clip. As described later, if the information on the radio wave intensity is not used during an operation that is performed by the smartphone and the management server 70, the information on the radio wave intensity does not need to be stored in the task assignment DB 73. Furthermore, if the information on the radio wave intensity is not used during the operation, the receiving unit 61 of the smartphone 50 does not need to measure the intensity of radio waves.

In the example of FIG. 10, the entry request is transmitted from the clip 10, that includes the identifier “ID001”. It illustrates that the management server 70 receives the entry request at the time “6:01” via the smartphone 50 and the intensity of the radio waves, measured when the smartphone 50 receives the entry request from the clip 10, is “XXX”. Furthermore, it illustrates that, with regard to the entry request, the task is assigned to the smartphone 50 that includes the identifier “SMP002”. Furthermore, various types of information, stored here, are stored by a determining unit 82 that is described later.

The control unit 80 is a processing unit that performs the overall operation of the management, server 70, and it is, for example, a processor. The control unit 80 includes a receiving unit 81, the determining unit 82, and a transmitting unit 83. Here, the receiving unit 81, the determining unit 82, and the transmitting unit 83 are an example of the electronic circuit, included in a processor, an example of the process that is executed by a processor, or the like.

The receiving unit 81 is a processing unit that receives various types of information, such as a task entry request or deletion request, from each smartphone. For example, the receiving unit 81 receives the entry request “holding state (Hold), identifier of clip, identifier of smartphone”, transmitted by the clip 10. Furthermore, the receiving unit 81 receives the deletion request, “holding state (Release), identifier of clip, identifier of smartphone”, transmitted by the clip 10. Furthermore, the receiving unit 81 receives the information, which is obtained by adding the identifier of the smartphone to the combination of “holding state, identifier of clip”, transmitted due to detection of a new BT connection destination by the clip 10.

That is, the receiving unit 81 receives the holding state of the clip 10 and the identifier of the clip 10 in accordance with a change in the state of the clip 10 or a change in the BT connection destination. Furthermore, as well as the above-described information, the receiving unit 81 receives the intensity of received radio waves when the smartphone receives the entry request from the clip. Furthermore, the receiving unit 81 outputs the received information to the determining unit 82.

The determining unit 82 is a processing unit that determines the destination, to which a task is assigned, and assigns the task to it. Specifically, if the received holding state of the clip 10 is (Hold) and the identifier of the clip 10 has not been registered yet, the determining unit 82 conducts task assignment. Furthermore, if the received identifier of the clip 10 has been registered and the received holding state is “Release”, the determining unit 82 conducts cancellation of task assignment. Furthermore, if the received identifier of the clip 10 has been registered and the received holding state is “Hold”, the determining unit 82 conducts task assignment determination by using the intensity of radio waves.

For example, if the holding state of the clip 10, received from the smartphone 50, is (Hold) and the identifier (ID001) of the clip 10 has not been registered in the task assignment DB 73, the determining unit 82 assigns the task to the smartphone 50. In this case, the determining unit 82 stores the reception time, the identifier (ID001) of the clip 10, the identifier (SMP002) of the smartphone 50, which is an assignment destination, and the measured intensity (XXX) of radio waves in a related manner in the task assignment DB 73. Then, the determining unit 82 requests the transmitting unit 83 to transmit a task registration command to the corresponding smartphone 50.

Furthermore, if the holding state of the clip 10, received from the smartphone 50, is (Release) and the identifier (ID001) of the clip 10 has been registered in the task assignment DB 73, the determining unit 82 cancels the task of the smartphone 50. In. this case, the determining unit 82 refers to the task assignment DB 73 and determines, the assignment destination. (SMP002) that is related to the identifier (ID001) of the clip 10. Then, the determining unit 82 requests the transmitting unit 83 to transmit a task deletion command to the smartphone 50 that is related to the corresponding assignment destination (SMP002).

Furthermore, if the holding state of the clip 10, received from the smartphone 50, is (Hold) and the identifier (ID001) of the clip 10 has been registered in the task assignment DB 73, the determining unit 82 determines whether the assignment destination of the task needs to be changed. For example, assume that, when the clip 10 transmits the entry request by broadcast, there happens to be multiple smartphones near the clip 10 and each smartphone receives the entry request from the clip 10. In this case, each of a smartphone A and a smartphone B, which has received the entry request, transmits its own identifier and the identifier of the clip 10 to the management server 70. Then, the management server 70 receives an entry request A, including the identifier of the clip 10 and the identifier of the smartphone A, and an entry request B, including the identifier of the clip 10 and the identifier of the smartphone B, during a predetermined time interval. If the smartphone that needs to be related to the clip 10 is the smartphone that is located at the position closer to the clip 10, the intensify of radio waves at the time of communication, performed between the clip 10 and each of the smartphones, may be used for determination. For example, the management server 70 first receives the entry request from the smartphone A and then receives the entry request from the smartphone B. The determining unit 82 compares the information on the radio wave intensity, included in the entry request with regard to the identifier (ID001) of the clip 10 at this time, with the radio wave intensity that has been registered in the task assignment DB 73. Then, the determining unit 82 assigns the task to the one with the higher radio wave intensity.

For example, if the registered smartphone A has a higher intensity of radio waves (that is, the smartphone A is located closer to the clip 10 as compared to B) during the wireless communication that is performed with the clip 10, the determining unit 82 determines that the task assignment does not need to be changed for the smartphone B that is received later, and it does not perform an operation to update the DB, make a notification, or the like. Conversely, if the newly received smartphone B has a higher radio wave intensity (that is, the smartphone B is located closer to the clip 10 as compared to A), the determining unit 82 makes a change to the task assignment. Specifically, the determining unit 82 updates the information about the identifier of the already registered smartphone 50 and the radio wave intensity in the task assignment DB 73 by using the identifier of the newly received smartphone 30 and the radio wave intensity. Furthermore, the determining unit 82 requests the transmitting unit 83 to transmit a task registration command to the smartphone 30, to which the new task is assigned, and transmit a task deletion command to the smartphone 50, of which the task assignment is terminated.

Furthermore, an explanation is given here of an example where, if the management server 70 receives the entry request that includes the identifier of the same clip from multiple smartphones during a predetermined time interval, the intensity of radio waves is used for determination as to which one of the smartphones it is related to; however, this is not a limitation. For example, it may be assigned simply in the order it is received. Specifically, the determining unit 82 may change the task assignment by giving priority to the smartphone 30, which newly transmits the identifier, or the like, over the registered smartphone 50 regardless of the radio wave intensity.

Furthermore, the user of the smartphone may specify which one of the smartphones the task is assigned to when it transmits the identifier of the clip 10 to the management server 70. If the identifier of the smartphone is specified as “task assignment destination” in the information, received from the smartphone, the determining unit 82 of the management server 70 assigns the task to the specified smartphone.

The transmitting unit 83 is a processing unit that transmits a task assignment command or a task deletion command to the corresponding smartphone. Specifically, the transmitting unit 83 transmits various commands in accordance with a request that is received from the determining unit 82. For example, the transmitting unit 83 transmits a task registration command that includes “identifier (ID001) of the clip 10, holding state (Hold)” to the smartphone 50, to which the task is assigned.

Furthermore, the transmitting unit 83 transmits the task deletion command, including “identifier (ID001) of the clip 10, holding state (Release)” to the smartphone 50 that is related to the completed task.

Furthermore, in accordance with a change in the task assignment, the transmitting unit 83 transmits the task deletion command, including “identifier (ID001) of the clip 10” to the smartphone 50 that is released from the task assigned. Furthermore, in accordance with a change in the task assignment, the transmitting unit 83 transmits a task registration command, including “identifier ID001) of the clip 10”, to the smartphone 30, to which the new task is assigned.

Explanation on Task Assignment

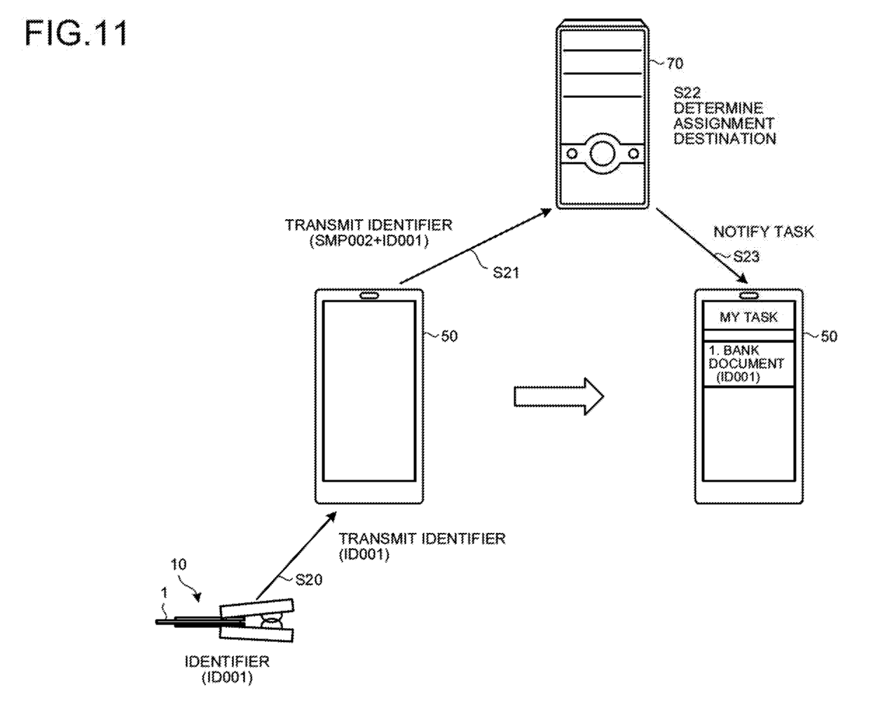

Next, an explanation is given of the task assignment according to the second embodiment. FIG. 11 is a diagram that illustrates the task assignment according to the second embodiment. As illustrated in FIG. 11, the clip 10 transmits the identifier of the clip 10 to the smartphone 50 via wireless communication. For example, if the clip 10 detects that the document 1 is nipped, it retrieves the terminal that is capable of short-range communication and transmits the identifier “ID001” of the clip 10 to the retrieved smartphone 50 (S20).

Next, after the smartphone 50 receives the identifier of the clip 10, it transmits the identifier “ID001” of the clip 10 and its own identifier “SMP002” to the management server 70 (S21).

Then, after the management server 70 receives the identifier “ID001” of the clip 10 and the identifier “SMP002” of the smartphone 50, it determines that the task assignment destination is the smartphone 50, as “ID001” is not registered (S22). Afterward, the management server 70 notifies the smartphone 50 of the task (S23). As a result, the smartphone 50 receives the task name to be displayed in relation to the task in accordance with a user's operation, for example, and registers the task “1, bank document” that, is related to the clip 10.

Explanation on Task Assignment Change

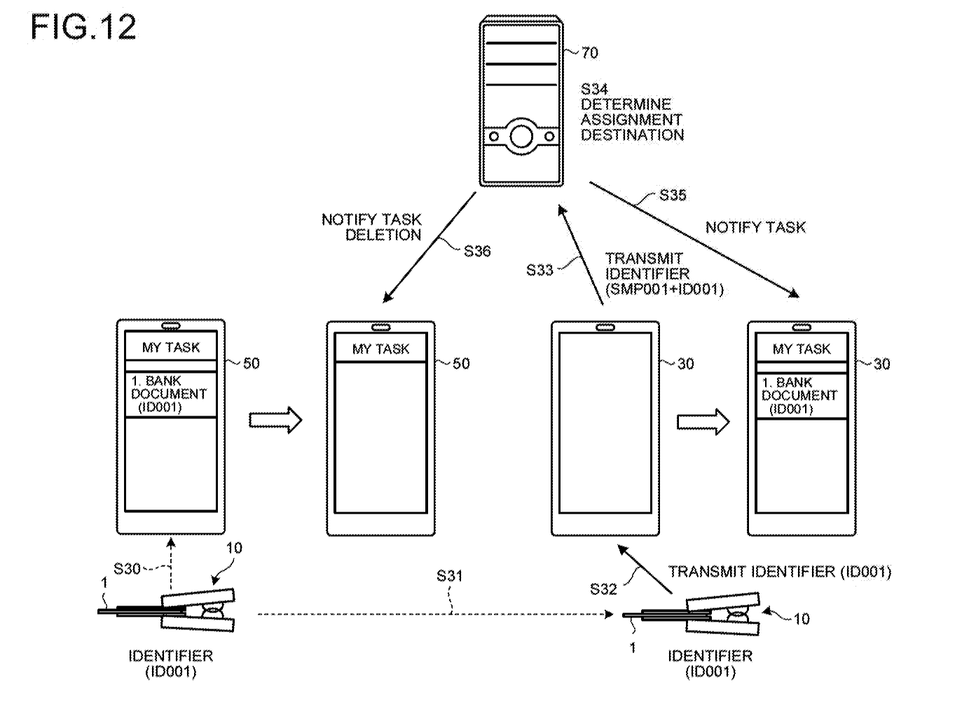

Next, an explanation is given of an example of a change in the task assignment according to the second embodiment. FIG. 12 is a diagram that illustrates an example of a change in the task assignment according to the second embodiment.

As illustrated in FIG. 12, after the clip 10 detects that the document 1 is nipped, it retrieves the terminal, which is capable of short-range communication, and transmits the identifier “ID001” of the clip 10 to the retrieved smartphone 50 (S30). Here, assume that the same operation as that of FIG. 11 is then performed and the task “1, bank document”, related to the clip 10, is already registered in the smartphone 50.

In the above-described state, assume that, the storage area of the clip 10, or the like, is changed, and the clip 10 detects the smartphone 30 as the terminal that is capable of a short-range communication (S31). For example, the above-described state is obtained when the document 1, nipped by the clip 10, is sent from the user who has the smartphone 50 to the user who has the smartphone 30, or the like. Then, the clip 10 transmits its own identifier “ID001” to the newly detected smartphone 30 (S32).

Next, after the smartphone 30 receives the identifier of the clip 10, it transmits the identifier “ID001” of the clip 10 and its own identifier “SMP001” to the management server 70 (S33).

Then, if the management server 70 receives the identifier “ID001” of the clip 10 and the identifier “SMP001” of the smartphone 30, it makes a determination on the task assignment destination, as “ID001” is registered in relation to “SMP002” of the smartphone 50 (S34). Here, the management server 70 changes the task assignment destination to the smartphone 30, as the intensity of radio waves, received from the smartphone 30, when the smartphone 30 receives the identifier of the clip 10 is higher than the intensity of radio waves, received from the smartphone 50, when the smartphone 50 receives the identifier of the clip 10 as described above, for example.

As a result, the management server 70 notifies the task assignment to the smartphone 30 (S35) and notifies the task deletion to the smartphone 50 (S36). Thus, the task, related to the clip 10, is moved from the smartphone 50 to the smartphone 30 in accordance with a movement of the clip 10, the smartphone 50, or the like.

Flow of Operation

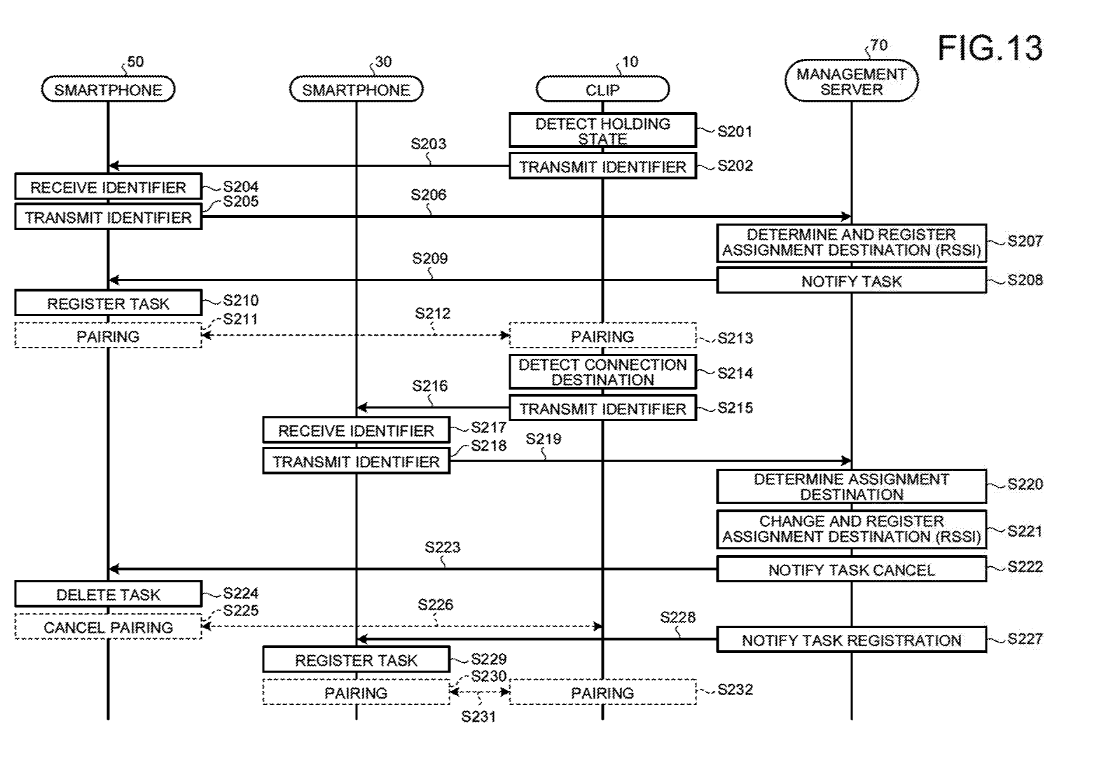

FIG. 13 is sequence diagram that illustrates the flow of an operation according to the second embodiment. As illustrated in FIG. 13, after the determining unit 21 of the clip 10 detects the holding state of the holding unit 14 (S201), the notifying unit 22 transmits the entry request, including the identifier (ID001), to the smartphone 50 (S202 and S203).

Then, the receiving unit 61 of the smartphone 50 receives the entry request, including the identifier, from the clip 10 (S204). Afterward, the transmitting unit 62 of the smartphone 50 transmits the received identifier “ID001” and its own identifier “SMP002” to the management server 70 (S205 and S206).

Next, the determining unit 82 of the management server 70 determines that the smartphone 50 is the assignment destination, as the identifier “ID001” of the clip 10, received from the smartphone 50, has not. been registered in the task assignment DB 73 (S207). Here, the determining unit 82 stores the intensity of radio waves, received from the smartphone 50, when the smartphone 50 receives the identifier of the clip 10 in the task assignment DB 73. Then, the transmitting unit 83 of the management server 70 notifies the task to the smartphone 50 (S208 and S209).

The registering unit S3 of the smartphone 50, which has received the notification, registers the task, related to the identifier “ID001” of the clip 10, in the task DB 55 (S210). Furthermore, the task registered here is the task (ID001).

Furthermore, if needed, the registering unit 63 of the smartphone 50 conducts, pairing for the clip 10, for which the task registration has been made (S211 to S213). Here, the timings for conducting pairing are not limited to those illustrated in the drawing, and it may be executed at any time between the task registration and the task start time.

Afterward, the notifying unit 22 of the clip 10 detects the smartphone 30, which is the new connection destination, in accordance with a movement, or the like (S214) and then transmits its own identifier “ID001” to the smartphone 30 (S215 and S216).

Then, the receiving unit 61 of the smartphone 30 receives the identifier “ID001” from the clip 10 (S217). Then, the transmitting unit 62 of the smartphone 30 transmits the identifier “ID001” of the clip 10 and its own identifier “SMP001” to the management server 70 (S218 and S219).

Afterward, the determining unit 82 of the management server 70 makes a determination en the assignment destination, as the identifier “ID001” of the clip 10, received from the smartphone 30, has been already registered as a task (S220). Then, the determining unit 82 determines that the smartphone 30 is an assignment destination on the basis of the intensity of radio waves, or the like (S221).

As a result, the transmitting unit 83 of the management server 70 transmits a task cancel notification with regard to the clip 10 to the smartphone 50 (S222 and S223). Then, the deleting unit 65 of the smartphone 50 deletes the task from the task DB 55 (S224) and cancels the pairing with the clip 10 (S225 and S226).

Conversely, the transmitting unit 83 of the management server 70 transmits a registration notification of the task, related to the clip 10, to the smartphone 30 (S227 and S228). Then, the registering unit 63 of the smartphone 30 registers the task in the task DB 55 (S229) and, if needed, conducts pairing with the clip 10 (S230 to S232). Here, the timings for conducting pairing are not limited to those illustrated in the drawing, and it may be executed at any time between the task registration and the task start time. Furthermore, the order of a cancel notification and a registration notification may be changed optionally.

Advantages

As described above, tasks may be easily registered in a smartphone by using the clip 10 and, if the clip 10 or the smartphone, for which the task has been registered, is moved, the task may be moved to a different smartphone. Therefore, a task may be shared by multiple persons, and a group task, or the like, may be managed. For example, after the task for settlement is generated by the user and is registered in his/her own smartphone, the task may be transmitted to the boss's smartphone automatically in accordance with an operation to hand the document related to the task to the boss; thus, the simplification of task management is improved, and the convenience for users is improved.

Furthermore, as the destination to which the task is assigned may be changed in accordance with the intensity of radio waves, urgent tasks, or the like, may be conducted by the person who is in the neighborhood instead of the person who has registered the task; therefore, it is possible to prevent human-induced mistakes, such as the task being left unexecuted.

### [c] Third Embodiment

Although the embodiments of the present invention have been described above, the present invention may be implemented by using various different embodiments other than the above-described embodiment.

Simultaneous Informing

For example, there is a case where, if there are multiple tasks, the execution order or the storage location of a clip is forgotten. In such a case, the smartphone 30 may transmit a vibration command or a lighting-up command to each clip that is related to each of the registered tasks.

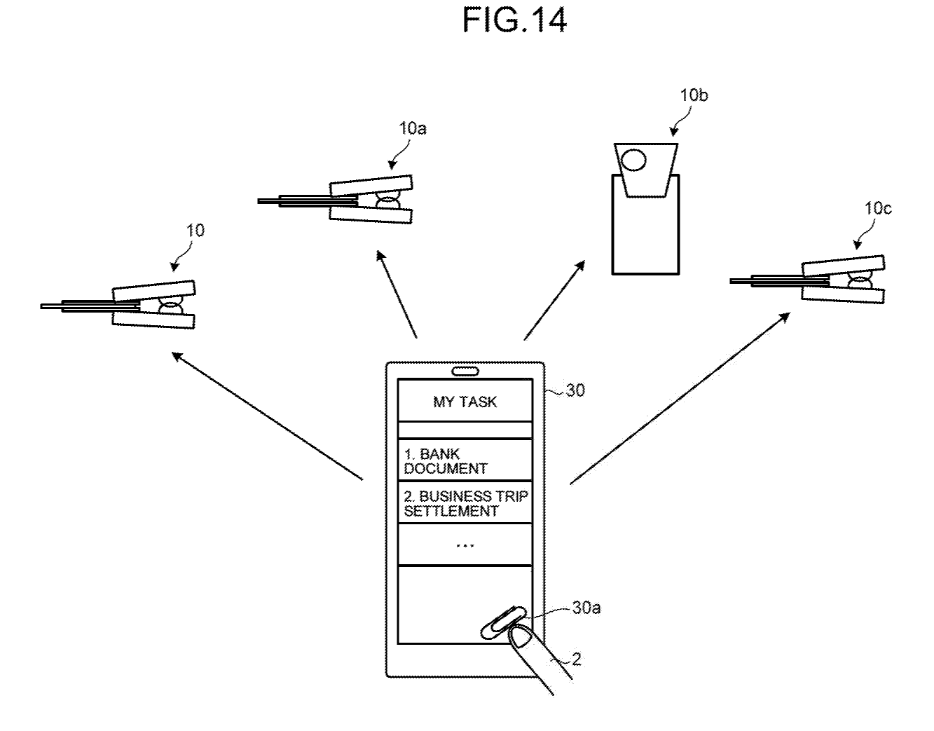

FIG. 14 is a diagram that illustrates an example of simultaneous informing to clips. As illustrated in FIG. 14, the informing unit 43 of the smartphone 30 displays a clip button 30a on the task list screen in a superimposed manner. Furthermore, if the clip button 30a is selected by a user 2, the informing unit 43 performs an operation to give information to each clip, related to each task.

For example, the informing unit 43 transmits a vibration command to the clip 10, related to the first task, and then transmits a vibration command to the clip 10a, related to the second task. Next, the informing unit 43 transmits a vibration command to a clip 10b, related to the third task, and then transmits a vibration command to a clip 10c, related to the fourth task.

This allows a user to check the position or the number of tasks. Although an explanation is given here by using a vibration command as an example, a lighting-up command may be used, or the combination of them may be used. Furthermore, the order the commands are transmitted may be optionally changed. Furthermore, according to the above-described embodiment, vibration and lighting are explained as an example of informing; however, these are not a limitation. For example, if the clip includes a speaker, it may output sounds in response to a command from the smartphone.

Alert Screen

Although the informing unit 43 of the smartphone 30 transmits a vibration command, or the like, to the clip that is related to the task, which reaches the start time, for example, the clip is sometimes not in the position that allows communications. In this case, the informing unit 43 of the smartphone 30 may display the alert screen on the display unit 32 so as to call user's attention.

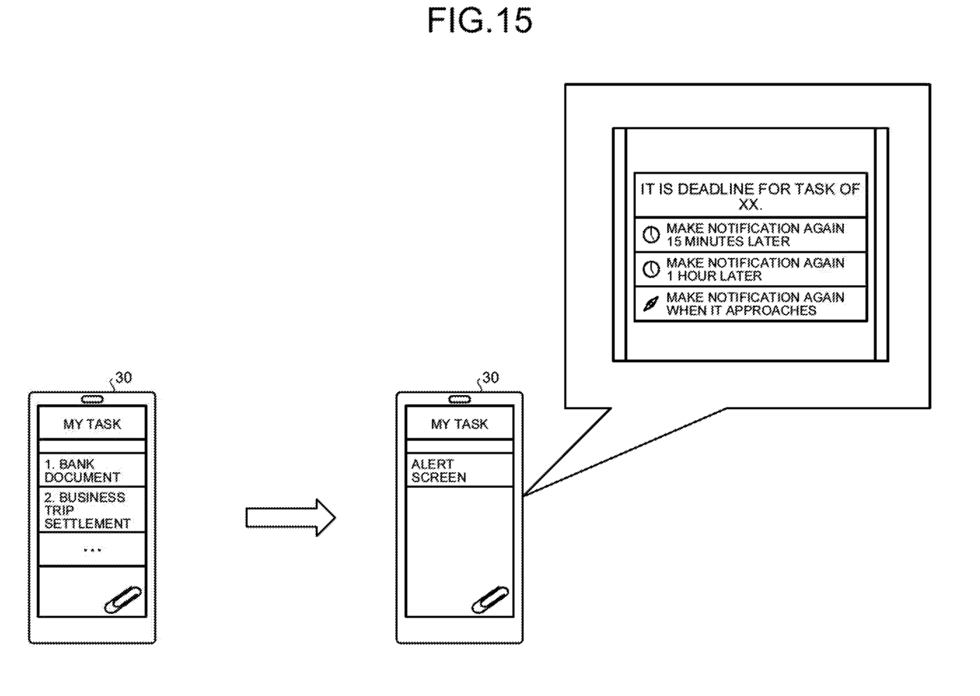

FIG. 15 is a diagram that illustrates an example of the alert screen when the clip is not in the neighborhood. As illustrated in FIG. 15, the informing unit 43 of the smartphone 30 displays the alert screen that describes “the deadline for the task of XX” if the clip, related to the task that reaches the start time, is not in the neighborhood. Furthermore, the informing unit 43 prompts the user to make a selection as to whether a notification is made again 15 minutes later, a notification is made again 1 hour later, or a notification is made again when the clip is detected, i.e., when a wireless communication is possible with the clip, and if makes a notification again in accordance with the selected details. Furthermore, the settings for a message on the screen, or the like, may be optionally changed.

Advance Registration in the Clip

For example, in the above-described embodiment, an explanation is given of an example where the smartphone and the management server relate a task with a clip; however, this is not a limitation. For example, the internal memory, or the like, of each clip may previously have registered therein the information related to a task. Specifically, each clip may have registered therein the task name. For example, the clip that is used for the task “overtime work calculation”, which is performed at the end of the month, the clip that is used for the task “morning meeting document”, which is performed every Monday, or the like, is previously generated. As described above, the clip, which is the target to be used, is previously defined for a cyclical task; thus, even if there are many clips, it is possible to prevent human-induced mistakes, such as nipping a wrong document with the clip.

Furthermore, multiple clips may be related to a single document. As an example of using multiple clips, there is a case where the task is executed every week but it is executed on a different day of the week on a week-to-week basis. In this case, the document is nipped with the clip for every week and the clip for the execution target day of the week. In this way, the document may be related to two tasks for every week and for the day of the week.

Determination on the Holding State

In the above-described embodiment, an explanation is given of the example where the holding state is determined by using the energization sensor 14a; however, this is not a limitation. For example, it is possible to use an angular sensor that detects the angle at which the two holding units 14 are separated from each other or a pressure sensor that detects the pressure of the two holding units 14. Furthermore, the resistance value, or the like, may be used, and any sensors may be used as long as it is a sensor that may detect the actions of the holding unit 14 to be opened or closed.

For example, after the task is registered, if the angular sensor detects that the angle becomes larger, it may be determined that a new document is additionally inserted and that the task is changed. In the same manner, after the task is registered, if the angular sensor detects that the angle becomes smaller, it may be determined that the document is removed and that the task is changed. If there is a change in the task as described above, the smartphone displays the information on the changed task on the screen. Furthermore, the smartphone may perform the same operation as the above-described task registration so as to perform reregistration of the task.

Information that is Transmitted from the Clip

In the above-described embodiment, an explanation is given of an example where the clip 10 transmits the identifier and the holding state; however, this is not a limitation, and various types of information may be transmitted. For example, the clip 10 may transmit predetermined time length information for specifying the informing timing, or the like, to the smartphone. Furthermore, the clip 10 may also transmit the time length information for specifying the task start time, or the like, to the smartphone.

Informing by the Clip

According to the above-described embodiment, the clip 10 starts to vibrate, turns on an LED, or the like, when it receives a vibration command, or the like, from the smartphone; however, this is not a limitation. For example, an internal memory, or the like, of the clip 10 stores the task start time, or the like, so as to autonomously conduct vibration start or turn-on of the LED.

Example Other than the Clip

For example, other than the above-described clip, the same operation as that in the above-described embodiment may be performed by attaching a small-sized electronic circuit to an envelope, file, or the like, that contains an object.

System

Furthermore, the components of each unit illustrated in the drawings are not always physically configured as illustrated in the drawings. Specifically, specific forms of separation and combination of each unit are not limited to those depicted in the drawings, and a configuration may be such that all or some of them are functionally or physically separated or combined in an arbitrary unit depending on various types of loads, usage, or the like. Moreover, all or any of various processing functions performed by each device may be implemented by a central processing unit (CPU). Furthermore, it is self-evident that all or any of the various processing functions may be implemented by programs, analyzed and executed by the CPU, or by wired logic hardware.

Furthermore, among the operations, described in the present embodiment, all or some of the operations that are automatically performed as described may be performed manually. Alternatively, all or some of the operations that are manually performed as described may be performed automatically by using a well-known method. Moreover, the operation procedures, the control procedures, the specific names, and the information including various types of data and parameters, described in the above specifications and the drawings, may be optionally changed except as otherwise noted.

Hardware

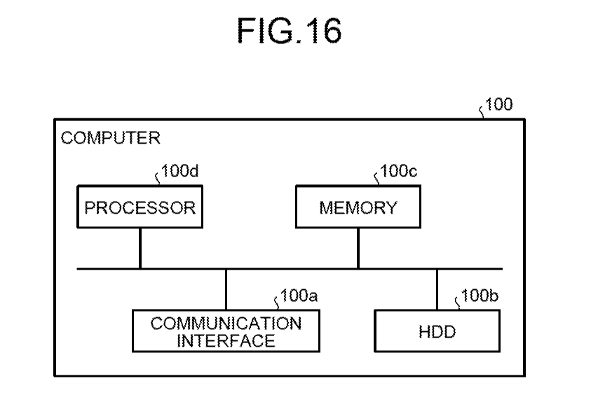

Each of the above-described devices may be implemented by a computer 100 that has, for example, the following hardware configuration. FIG. 16 is a diagram that illustrates an example of the hardware configuration. As illustrated in FIG. 16, the computer 100 includes a communication interface 100a, a hard disk drive (HDD) 100b, a memory 100c, and a processor 100d.

Examples of the processor 100d include a CPU, a digital signal processor (DSP), a field programmable gate array (FPGA), or a programmable logic device (PLD). Furthermore, examples of the memory 100c include a random access memory (RAM), such as a synchronous dynamic random access memory (SDRAM), a read only memory (ROM), or a flash memory.

Furthermore, the clip 10 is operated as an information processing apparatus that implements a notification method by reading and executing a program. Specifically, the clip 10 executes programs for implementing the same functions as those of the determining unit 21 and the notifying unit 22. As a result, the clip 10 may execute the processes for implementing the same functions as those of the determining unit 21 and the notifying unit 22. Furthermore, a program in the other embodiments is not limited to being executed by the clip 10. For example, the present invention may be also applied to a case where a program is executed by a different computer or server, or a case where a program is executed by them in cooperation.

The program may be distributed via a network, such as the Internet. Furthermore, the program is recorded in a recording medium readable by a computer, such as a hard disk, a flexible disk (FD), a CD-ROM, a magneto-optical disk (MO), or a digital versatile disk (DVD), and it may be executed by being read from the recording medium by the computer. Moreover, although an explanation is given here by using the clip 10 as an example, the same operation may be performed for each smartphone or the management server 70.

According to the embodiment, tasks may be easily managed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A management device for an object comprising:
a memory; and
a processor that is connected to the memory, wherein the processor executes a process including:
detecting a physical link with an object is generated and/or a physical link with an object is eliminated; and
transmitting an identifier of the management device when detecting that the physical link with the object is generated or the physical link with the object is eliminated.

2. The management device for an object according to claim 1, wherein, when the management device detects that the object is nipped, the detecting includes detecting that the physical link with the object is generated.

3. The management device for an object according to claim 1, wherein, when detecting that a state of nipping the object by the management device is changed into a state of not nipping the object by the management device, the detecting includes detecting that the physical link with the object is eliminated.

4. A clip comprising:
a holding unit;
a determining unit that determines a state of the holding unit; and
a wireless communication unit that, when the determining unit determines that the holding unit is in a holding state, transmits a signal that prompts a task management device to have an entry for a new task.

5. The clip according to claim 4, wherein the signal includes a time at which the holding unit enters a holding state and/or information on a predetermined time length that is used for management of the new task.

6. The clip according to claim 4, further comprising:
a light emitting device or a speaker; and
a control unit that controls the light emitting device so as to emit light or controls the speaker so as to generate sound when the wireless communication unit receives a signal, transmitted from the task management device, in accordance with detection of non-completion of the new task after an elapse of a time that corresponds to the predetermined time length in a case where the signal includes the information on the predetermined time length.

7. The clip according to claim 4, wherein the signal is information on a predetermined time length for a deadline for completing the new task.

8. The clip according to claim 4, wherein the signal includes identification information on the clip.

9. The clip according to claim 8, further comprising:
a light emitting device or a speaker; and
a control unit that controls the light emitting device so as to emit light or controls the speaker so as to generate sound when the wireless communication unit receives a signal, transmitted from the task management device.

10. The clip according to claim 4, wherein, when the determining unit determines that the holding unit changes from a holding state to a non-holding state, the wireless communication unit transmits a signal that prompts the task management device to delete the entry for the new task.

11. The clip according to claim 4, wherein, when the determining unit determines that the holding state of the holding unit is changed, the wireless communication unit transmits a change notification related to the new task to the task management device.

12. An object management system comprising:
a management device for an object including:
a first memory; and
a first processor that is connected to the first memory, wherein the first processor executes a first process including:
detecting that a physical link with an object is generated, and
sending an identifier of the management device when detecting the physical link with the object is generated; and
a first, computer including:
a second memory; and
a second processor that is connected to the second memory, wherein the second processor executes a second process including:
receiving the identifier of the management device, sent by the management device,
storing the received identifier of the management device to the second memory, and
displaying information about the identifier of the management device, stored in the second memory.

13. The object management system according to claim 12, wherein, the second process further includes storing the identifier of the management device in the second memory in a case where the received identifier of the management device is an unregistered identifier and, in a case where the identifier has been registered, deleting the identifier of the management device from the second memory or further storing information that indicates completion in relation to the identifier of the management device.

14. The object management system according to claim 12, wherein
the second process computer further includes, when a predetermined condition is satisfied, transmitting an operation command to the management device that is specified by using the identifier of the management device, stored in the second memory, and
the first process further includes
receiving the operation command, and
performing a predetermined operation upon receiving the operation command.

15. The object management system according to claim 12, wherein
the receiving of the second process of the first computer includes receiving an identifier from each of the management devices, and
the storing of the second process of the first computer includes storing the received identifier in order of reception and, when the predetermined condition is satisfied, meaning that it is detected that a link with an object, related to a first management device, is eliminated in accordance with information that is received from the first management device, transmitting the operation command to a second management device that is stored subsequent to the first management device in the order of storage.

16. An object management system comprising:
a management device for an object including:
a first, memory; and
a first processor that is connected to the first memory, wherein the first processor executes a first process including:
detecting a physical link with an object is generated, and
sending an identifier of the management device when detecting that the physical link with the object is generated;
a first, computer including:
a second memory; and
a second processor that is connected to the second memory, wherein the second processor executes a second process including;
receiving the identifier .of the management device, sent from the management device, and
transmitting the received identifier of the management device and an identifier of the first computer; and
a second computer including:
a third memory; and
a third processor that is connected to the third memory, wherein the third processor executes a third process including:
receiving the identifier of the management device and the identifier of the first computer, transmitted from the first computer, and
storing the identifier of the management device and the identifier of the first computer in a related manner in a case where the received identifier of the management device has not been stored, and updating an identifier of a fourth computer, stored in relation to the identifier of the management device, by using the received identifier of the first computer in a case where the received identifier of the management device has been stored.

17. The object management system according to claim 16, wherein the third process further includes updating the identifier of the fourth computer, stored in relation to the identifier of the management device, by using the received identifier of the first computer in a case where the received identifier of the management device has been stored and transmitting information that indicates a relation with the identifier of the management device is eliminated to the fourth computer, indicated by the stored identifier of the fourth computer.
